(19) United States
(12) Patent Application Publication
(10) Pub. No.: US 2015/0342219 A1
(43) Pub. Date: Dec. 3, 2015

(54) SHELF-STABLE ICE CREAM AND ICE CREAM MIX AND PROCESS FOR MAKING SAME WITH AGAVE NECTAR

(71) Applicants: Jean Zwarg, Rancho Palos Verdes, CA (US); Stacey Ralphs, La Canada, CA (US)

(72) Inventors: Jean Zwarg, Rancho Palos Verdes, CA (US); Stacey Ralphs, La Canada, CA (US)

(21) Appl. No.: 14/726,141

(22) Filed: May 29, 2015

Related U.S. Application Data
(60) Provisional application No. 62/004,973, filed on May 30, 2014.

(51) Int. Cl. A23G 9/36; A23G 9/34

(52) U.S. Cl. CPC A23G 9/363; A23G 9/34; A23V 2002/00

(57) ABSTRACT

Methods for making an ice cream mix or ice cream-like mix are disclosed, the methods including forming a mixture that includes one or more dairy products wherein at least one of the one or more dairy products comprises lactose, one or more stabilizers, and agave nectar, the method further including pasteurizing the mixture; and contacting at least some of the lactose with an enzyme at a temperature and for a time sufficient to allow the enzyme to reduce the lactose content of the mixture. Ice cream and ice cream-like products are also disclosed. An ice cream that includes one or more dairy products, agave nectar (or derivative thereof), and lactase.

### CROSS-REFERENCE TO RELATED APPLICATIONS

This application claims the benefit of U.S. Provisional Patent Application No. 62/004,973, filed on May 30, 2014, the contents of which are incorporated herein by reference in its entirety.

### STATEMENT REGARDING FEDERALLY SPONSORED RESEARCH

Not Applicable.

### BACKGROUND

1. Field

This disclosure relates to an improved method for making a dairy composition (e.g., ice cream mix, etc.) for use in making an ice cream formulation having an extended shelf life. This disclosure also relates to improved dairy compositions (e.g., ice cream, ice cream mix, etc.).

2. Description of the Related Art

There has been an increasing public awareness of the effects of obesity and being overweight in the United States and beyond. Many individuals seek foods that will help maintain weight or seek foods that substitute for higher-caloric foods.

Many individuals seek reduced-calorie and/or reduced-sugar foods in prevention of or on-going treatment and/or maintenance of various medical conditions such as, for example, diabetes, heart disease, hypertension, etc.

Ice cream and ice cream-like foods have been very popular despite increased sugar and calorie content. However, improvements in ice cream are desired.

For example, ice creams are sought that have reduced calories and have desirable aroma, taste, and texture (e.g., “mouth feel”) as traditional ice creams.

Attempts to develop frozen lower-calorie desserts include those described in the following patents: U.S. Pat. No. 4,663,176 (Arden); U.S. Pat. No. 4,657,200 (Serpelloni); U.S. Pat. No. 5,084,295 (Whelan); U.S. Pat. No. 5,145,698 (Cajigas); U.S. Pat. No. 5,328,710 (Malone); U.S. Pat. No. 5,358,728 (Martin); and U.S. Pat. No. 6,511,694 (Huang).

Agave nectar has been utilized as a component in sweetening compositions, as described in the following patent publication: US 2009/0104326 (Catani); US 2010/0040757 (Chin); US 2009/0029010 (Dince).

The benefits of agave nectar are numerous. For example, US 2014/0044858 (Quevedo) describes agave nectar as a natural product with health benefits, wherein the agave nectar is significantly sweeter than table sugar, but has a low glycemic index. Hence, lesser amounts of agave may be used, relative to table sugar. However, as further discussed in patent publication US 2014/0044858 (Quevedo), removing sugar from, for example, ice cream may result in a compromised Texture—for example, ice cream made with an artificial sweetener may include undesirable ice crystals (“sandy” texture) and may be unpleasantly hard.

Further, ice creams need to have an extended shelf life.

Thus, there exists a need for improved methods of making an ice cream mix for use in making ice cream having an appropriate texture and an extended shelf life.

Without limiting the scope of the present disclosure, a brief summary of some of the claimed embodiments of the present disclosure is provided below. Additional details of the summarized embodiments and/or additional embodiments of the present disclosure can be found in the detailed description. A brief abstract of the technical disclosure in the specification is provided as well for the purposes of complying with 37 C.F.R. §1.72. The abstract is not intended to be used for interpreting the scope of the claims.

All patents, patent applications, and all other published documents mentioned anywhere in this application are hereby incorporated herein by reference, each in its entirety.

### BRIEF SUMMARY

One or more aspects of the present disclosure relates to a method for making an ice cream mix or ice cream-like mix. The method includes forming a mixture that includes agave nectar, one or more stabilizers, and one or more dairy products wherein at least one of the one or more dairy products includes lactose. The method also includes pasteurizing the mixture and contacting at least some of the lactose with an enzyme at a temperature and for a time sufficient to allow the enzyme to reduce the lactose content of the mixture. In one or more embodiments, lactose crystallization is reduced or eliminated when the ice cream mix or ice cream-like mix is subsequently frozen into an ice cream or ice cream-like composition. In one or more embodiments, the shelf life of the ice cream was increased to approximately 2 years, which is a significant improvement.

### BRIEF DESCRIPTION OF THE SEVERAL VIEWS OF THE DRAWING(S)

None.

### DETAILED DESCRIPTION

In the present disclosure, methods of making an ice cream mix or ice cream-like mix having increased shelf stability are disclosed. For example, in one or more embodiments, a method for making an ice cream mix or ice cream-like mix includes forming a mixture, pasteurizing the mixture; and contacting at least some of the lactose from the mixture with an enzyme. Contacting at least some (e.g., all) of the lactose with an enzyme may be accomplished at a temperature and for a time sufficient to allow the enzyme to reduce the lactose content of the mixture.

In one or more embodiments, the mixture includes one or more dairy products, wherein at least one of the one or more dairy products includes lactose. A wide variety of dairy products is available commercially and may be used in the methods of the present disclosure. As used herein, “dairy product” refers to milk obtained from a mammal (e.g., cow, goat, etc.) and milk products derived therefrom including, but not limited to milk of any suitable fat content (e.g., skim milk, 1% milk, 2% milk, whole milk, etc.), milk according to any of the USDA's Classes I-IV, cream according to any of USDA's Classes I-IV, cream obtained from mammalian milk, powdered milk (e.g., nonfat dry milk Grade A, etc.), concentrated milk, etc.

In the methods of the present disclosure, the relative amounts of milk and cream may be any suitable value provided that the butterfat content of the combination is in a range of 10-20% by weight based on the weight of the milk and milk derivatives (e.g., 10-16%, 12-16%, 13-15%, 13.5%-14.5%, about 14%, etc.).

The mixture also includes one or more stabilizers. As used herein, “stabilizer” means any conventionally used ingredient for stabilizing frozen confections, such as, but not limited to, agar, gelatine, gum acacia, pectin, guar gum, locust bean gum, tara gum, gum tragacanth, xanthan, carrageenan, seaweed, carboxymethyl cellulose, microcrystalline cellulose, sodium alginate, carob gum, guar gum and alginate. In the present disclosure, any of a wide variety of stabilizers may be used. For example, a stabilizer may include, but is not limited to, one or more of lecithin (e.g., CC230 lecathin from Scott Brothers Dairy, Chino, Calif.), locust bean gum (e.g., carob gum, carobin, E410, etc.), guar gum (e.g., guaran, etc.), and SSD-6288 (CC305) Nat IC Stab from Scott Brothers Dairy, Chino, Calif. In the present disclosure, an ice cream mix may include one or more stabilizers in an amount from 0-1% (e.g., 0.01-1%, 0.1-1%, 0.1-0.5%, 0.2-0.5%, 0.3-0.35%, about 0.32%, etc.) by weight based on the combined weight of the agave nectar, the one or more dairy products, and the one or more stabilizers. In one or more embodiments, an ice cream mix may include one or more stabilizers in an amount from 0-1% (e.g., 0.01-1%, 0.1-1%, 0.1-0.5%, 0.2-0.5%, 0.3-0.35%, about 0.32%, etc.) by volume based on the combined volume of the agave nectar, the one or more dairy products, and the one or more stabilizers.

In the present disclosure, adding one or more stabilizers to one or more components of the mixture may include mixing the one or more components of the mixture until the stabilizers are substantially homogeneously distributed.

The mixture also includes agave nectar and/or a derivative thereof. In the present disclosure, agave nectar is present in a non-zero quantity up to about 40% (e.g., 1-20%, 5-20%, 5-15%, 8-12%, 9-11%, about 10%, etc.) by volume based on the sum of the one or more dairy products, the one or more stabilizers, and the agave nectar.

If an agave nectar derivative (e.g., agave powder, dried agave, agave crystals, etc.) is used in the present disclosure, a suitable amount of the agave nectar derivative is an amount having a sweetness equivalent to the volumes of agave nectar described herein. In one or more embodiments, the agave nectar may include liquid agave nectar and/or solid agave sweetener (e.g., agave sweetener crystals, which may be milled into smaller crystals and/or a powder, dry agave sweetener, etc.) such as that described in U.S. Pat. Appl. Pub. No. 2014/0044858 (Quevedo).

Any of a wide variety of enzymes may be employed in the one or more embodiments of the present disclosure, including, but not limited to lactase. In some embodiments, the enzyme includes only lactase. For example, lactase (e.g., lactase-phlorizin hydrolase), when added to the mixture in suitable amounts and under suitable conditions, will contact and/or chemically react with lactose (e.g., D-lactose) and chemically convert the lactose via hydrolysis into chemical by-products, such as constituent galactose (e.g., D-galactose) and glucose (e.g., D-glucose) monomers. In the present disclosure, an enzyme may be added to the mixture in any suitable amount wherein the enzyme can reduce and/or eliminate the content of the lactose. For example, an enzyme (e.g., lactase, etc.) may be added in an amount of at least 1 gram per 100 gallons (378.5 liters) of pasteurized ice cream mix. In some embodiments, the amount of enzyme may be at least 40 grams (e.g., at least 100 grams, at least 250 grams, at least 500 grams, at least 1,000 grams, etc.) per 100 gallons (378.5 liters) of ice cream mix.

Lactase is available commercially from a wide variety of sources. For example, CHR Hansen (Denmark) makes commercially available a product called Ha Lactase™ with 2,100 or 5,200 neutral lactase units per gram. Danisco (a Dupont company) also makes commercially available a suitable lactase product (e.g., GODO-YNL2 lactase, etc.).

In some embodiments, the forming of the mixture occurs, followed by pasteurization of the mixture. Pasteurization of a dairy composition is well known in this technology area. Any suitable technique for pasteurization may be employed in the present disclosure. For example, pasteurization may be performed according to the Grade “A” Pasteurized Milk Ordinance 2009 Revision (U.S. Dept. of Health and Human Services, Public Health Service, Food and Drug Administration) incorporated herein by reference in its entirety, the 2011 revision thereof, and subsequent revisions thereof.

In at least some embodiments, the contacting of lactose with an enzyme occurs following pasteurization of the mixture containing lactose. As mentioned herein, an enzyme may act to reduce the lactose content of the mixture via, for example, hydrolysis. In some embodiments of the present disclosure, an enzyme is used in suitable quantity and under suitable conditions to reduce the lactose content by 1% or more (e.g., 10% or more, 25% or more, 50% or more, 75% or more, 90% or more, 95% or more, 99% or more). In some embodiments, the lactose content of the mixture is reduced by 99.9% or more. In some embodiments, the lactose content is reduced such that lactose cannot be detected by testing according to the AOAC 982.14 method (1983). In one or more embodiments, the lactose content is reduced 100%.

In some embodiments, at least some of the contacting of the lactose with an enzyme occurs at refrigerated temperatures, such as, for example, 34-40 degrees F. (1.11-4.44 degrees Celsius). In one or more embodiments, the contacting occurs at a refrigerated temperature for a time ranging from about 1 hour to about 1 week (e.g., 1 hour-6 days, 3 hours-6 days, 6 hours-4 days, 12 hours-3 days, 1-3 days, 1.5-2.5 days, about 2 days, etc.). In some embodiments, the contacting occurs over a time period longer than 1 week. In some embodiments, at least some of the contacting of the lactose with an enzyme occurs at a temperature greater than 40 degrees F. (4.44 degrees Celsius). In some embodiments, at least some of the contacting of the lactose with an enzyme occurs at a temperature lower than 34 degrees F. (1.11 degree Celsius), such as during the ice cream making process.

Although not wishing to be bound by theory, it is believed that the combined use of agave sweetener (e.g., agave nectar) and an enzyme (e.g., lactase, etc.) as described herein results in an ice cream with reduced (or eliminated) lactose content, thereby increasing the shelf stability of the ice cream relative to a similarly produced ice cream made without the enzyme (e.g., lactase) and/or relative to a similarly produced ice cream made without the agave sweetener. It is believed that the ice cream's increase in shelf stability is due at least in part to a reduction of or elimination of lactose crystallization, which had occurred in similarly produced ice creams due at least in part to the low viscosity of agave nectar and the reduced solids as compared to an ice cream made with traditional dry sugar (and no sugar substitutes). In one or more embodiments, an ice cream mix described herein may be used to make an ice cream that has a shelf-stable life of approximately 2 years, which is a significant improvement in the field, particularly with regard to ice creams made using agave nectar.

In one or more aspects of the present disclosure, an ice cream mix or ice cream-like mix may be produced by one or more of the methods disclosed herein. In one or more embodiments, the ice cream is formed from a process wherein contacting at least some of the lactose with an enzyme occurs at a temperature and for a time sufficient to reduce or eliminate lactose crystallization in the ice cream or ice cream-like product relative to a similarly formed ice cream or ice cream-like product without contacting at least some lactose with an enzyme.

In one or more aspects of the present disclosure, a method for forming an ice cream or ice cream-like product may include forming an ice cream mix or ice cream-like mix according to one or more of the methods disclosed herein and freezing at least a portion of the ice cream mix or ice cream-like mix. In some embodiments, inclusions are added to the ice cream mix or ice cream-like mix before or after freezing at least a portion of the ice cream mix.

After an ice cream mix is made in accordance with one or more methods described herein, the mix may be provided to a copacker for addition of one or more flavorants and or inclusions during the ice cream making process. The use of ice cream mix and the making of ice cream are considered well known.

The flavorant may include or by derived from one or more of the following: a fruit and/or a berry (e.g., banana, raspberry, strawberry, apricot, blueberry, apple, pear, mango, papaya, citrus, orange, etc.), a nut (e.g. hazel nut, almond, pine nut, pistachio, cashew nut, etc.), a spice (e.g. chai, basil, cardamom, cinnamon, thyme, etc.), a flower (e.g. rose, elderflower, etc.), a root (e.g. licorice, etc.), a plant (e.g., vanilla, mint, fir, tea, etc.), as well as other sources (e.g., honey, etc.). A flavorant may include an ingredient such as, but not limited to, cocoa, chocolate, coffee, mocha, caramel, caramel essence, nougat, nougat essence, marzipan, almond essence, oils, liquor, brandy, rum, port, whiskey, wine, etc.

In some embodiments, a vanilla ice cream may be made by combining from 0.5 to 3 (e.g., about 1.5, etc.) gallons of vanilla extract (e.g., pure vanilla extract) with 100 gallons (378.5) ice cream mix and freezing the resulting mixture with conventional ice cream manufacturing equipment and procedures. Alternatively, a chocolate ice cream may be made by thoroughly mixing 50 pounds (22.68 kg) of cocoa and 2.5 gallons (9.46 liters) of water with 100 gallons (378.5) of ice cream mix and freezing the resulting mixture with conventional ice cream manufacturing equipment and procedures.

In one or more aspects of the present disclosure, an ice cream mix or ice cream-like mix may include a pasteurized mixture that includes one or more dairy products and agave nectar and further includes lactase. As disclosed herein an ice cream mix may also include one or more stabilizers. In one or more embodiments of the present disclosure, an ice cream or an ice cream-like product may include such an ice cream mix or ice cream-like mix, wherein at least a portion of which is frozen after mixing with one or more flavorants, as described herein. In one or more aspects of the present disclosure, an ice cream or an ice cream-like product may include (or be made from) one or more dairy products, agave nectar, and lactase. In one or more embodiments, the lactase may be present in an amount of 50 grams or more (e.g., 100 grams or more, 200 grams or more, 300 grams or more, 400 grams or more, 500 grams or more, etc.) per 100 gallons (378.5 liters) of ice cream. Optionally, the ice cream or ice cream-like product may include one or more stabilizers, flavorants, inclusions, etc.

### EXAMPLE 1A

An ice cream mix was formulated from ingredients purchased from Scott Brothers Dairy (Chino, Calif.) according to the following procedure:

(1) The following ingredients were combined:

49.9 gallons (188.89 liters) of milk (“Class 3—Milk” from Scott Brothers Dairy),

34 gallons (128.7 liters) of cream (“Class 3—Cream” from Scott Brothers Dairy), and

75 pounds (34.02 kg) of powdered Grade A nonfat dry milk (“Pdr—Non Fat Dry Milk Grade A” from Scott Brothers Dairy).

(2) To that mixture, 10 gallons (37.85 liters) of agave nectar liquid sweetener (“Swtnr—Agave Nectar (Liquid)” from Scott Brothers Dairy) was stirred in.

(3) To that mixture, 0.4 pounds (0.18 kg) of lecithin (“Stblz—CC230 Lecathin” from Scott Brothers Dairy) and 2.5 pounds (1.13 kg) of an ice cream stabilizer composition (“Stblz—SSD-6288 (CC305) Nat IC Stab” from Scott Brothers Dairy) were added as stabilizers.

(4) The mixture was pasteurized according to the Grade “A” Pasteurized Milk Ordinance.

(5) 45 grams of Ha Lactase(TM) (5200 NLU/g) (CHR Hansen; Denmark) (“CHR Hansen Ha Lactase 5200 #697066” from Scott Brothers Dairy) was stirred into the pasteurized mixture and refrigerated at 34-40 deg. F (1.11-4.44 deg. Celsius) for 1 hour.

### EXAMPLE 1B

An ice cream mix was formulated in accordance with the procedure set forth in EXAMPLE 1A, except that the amount of Ha Lactase™ used was 300 grams and the pasteurized mixture with Ha Lactase mixed in was refrigerated at 34-40 deg. F (1.11-4.44 deg. Celsius) for 48 hours.

### EXAMPLE 2

A sample of the ice cream mix of EXAMPLE 1B was tested in accordance with the method of AOAC Official Methods of Analysis test AOAC 982.14-1983 (“Glucose, Fructose, Sucrose, and Maltose in Presweetened Cereals—Liquid Chromatographic Method”; AOAC International, 1983) using high performance liquid chromatography (HPLC). The resulting sugar profile was as follows:

| | |
|---|---|
| Fructose, HPLC | 6.20% |
| Glucose/dextrose, HPLC | 5.32% |
| Sucrose, HPLC | None Detected (Less Than 0.10%) |
| Maltose, HPLC | None Detected (Less Than 0.10%) |
| Lactose, HPLC | None Detected (Less Than 0.10%) |

### EXAMPLE 3A

The ice cream mix of EXAMPLE 1A was provided to a copacker where an ice cream was made in accordance with typical ice cream making equipment and procedures. The ice cream had a shelf life of 6 months, after which lactose crystallization was detected.

### EXAMPLE 3B

The ice cream mix of EXAMPLE 1B was provided to a copacker where an ice cream was made in accordance with typical ice cream making equipment and procedures. The ice cream included no lactose crystallization and had a shelf life of 2 years.

### EXAMPLE 4

Vanilla ice cream was made by mixing 1.5 gallons (5.68 liters) of vanilla extract with 100 gallons (378.5 liters) of ice cream mix from EXAMPLE 1B and freezing the resulting mixture with conventional ice cream manufacturing equipment and procedures.

### EXAMPLE 5

Ice cream was made by mixing 50 pounds (22.68 kg) of cocoa and 2.5 gallons (9.46 liters) of water with 100 gallons (378.5) of ice cream mix from EXAMPLE 1B and freezing the resulting mixture with conventional ice cream manufacturing equipment and procedures.

1. A method for making an ice cream mix or ice cream-like mix comprising:
forming a mixture comprising:
one or more dairy products wherein at least one of the one or more dairy products comprises lactose;
one or more stabilizers; and
agave nectar;
pasteurizing the mixture; and
contacting at least some of the lactose with an enzyme at a temperature and for a time sufficient to allow the enzyme to reduce a lactose content of the mixture.

2. The method of claim 1, wherein the enzyme comprises lactase.

3. The method of claim 1, wherein the contacting occurs after the pasteurizing.

4. The method of claim 1, wherein the one or more dairy products comprises milk and cream.

5. The method of claim 1, wherein the one or more stabilizers comprises one or more of lecithin, locust bean gum, and guar gum.

6. The method of claim 1, wherein the one or more stabilizers is present in a quantity of about 0.32% by volume based on the sum of the one or more dairy products, the one or more stabilizers, and the agave nectar.

7. The method of claim 1, wherein the agave nectar is present in a non-zero quantity of about 10% by volume based on the sum of the one or more dairy products, the one or more stabilizers, and the agave nectar.

8. The method of claim 1, wherein the lactase is added to the pasteurized mixture in a non-zero amount of about 300 grams per 100 gallons of pasteurized mixture.

9. The method of claim 1, wherein allowing the enzyme to reduce the lactose content of the pasteurized mixture comprises refrigerating the pasteurized mixture for about 48 hours.

10. The method of claim 1, wherein contacting at least some lactose with an enzyme comprises allowing at least some of the lactose to chemically react to form chemical by-products.

11. The method of claim 1, wherein contacting at least some lactose with an enzyme comprises allowing at least some of the lactose to chemically react to form glucose and galactose.

12. The method of claim 1, wherein the contacting occurs at a refrigerated temperature and for a time of about 48 hours.

13. An ice cream mix or ice cream-like mix produced by a method according to claim 1.

14. An ice cream or ice cream-like product formed from the ice cream mix or ice cream-like mix of claim 13 wherein the contacting at least some of the lactose with an enzyme occurs at a temperature and for a time sufficient to reduce or eliminate lactose crystallization in the ice cream or ice cream-like product relative to a similarly formed ice cream or ice cream-like product without contacting at least some lactose with an enzyme.

15. A method for forming an ice cream or ice cream-like product comprising:
forming an ice cream mix or ice cream-like mix according to claim 1; and
freezing at least a portion of the ice cream mix or ice cream-like mix.

16. The method of claim 15, further comprising adding inclusions to the ice cream mix or ice cream-like mix.

17. An ice cream or ice cream-like product produced by a method according to claim 15.

18. An ice cream mix or ice cream-like mix comprising:
a pasteurized mixture comprising one or more dairy products and agave nectar; and
lactase.

19. An ice cream or an ice cream-like product comprising:
the ice cream mix or ice cream-like mix of claim 18, at least a portion of which is frozen after mixing with a flavorant selected from vanilla extract and cocoa.

20. An ice cream or an ice cream-like product comprising:
one or more dairy products;
agave nectar; and
lactase.
